(19) United States
(12) Patent Application Publication
(10) Pub. No.: US 2024/0329677 A1
(43) Pub. Date: Oct. 3, 2024

(54) BIAS-LESS TECHNIQUE FOR DESIGN OF A DIGITAL LINEAR VOLTAGE REGULATOR

(71) Applicant: Intel Corporation, Santa Clara, CA (US)

(72) Inventors: Kosta Luria, Pardesiya (IL); Michael Zelikson, Haifa (IL); Lior Gil, Haifa (IL)

(21) Appl. No.: 18/192,440

(22) Filed: Mar. 29, 2023

(51) Int. Cl. G05F 1/575; G05F 1/565; G05F 1/59

(52) U.S. Cl. CPC G05F 1/575; G05F 1/565; G05F 1/59

(57) ABSTRACT

Embodiments herein relate to a Digital Linear Voltage Regulator (DLVR). The DLVR includes a set of power links which each includes many columns of power transistors. The columns can be turned on or off individually based on digital data from a main control circuit. Additionally, individual power links can be turned on or off based on monitoring of a dropout voltage of the set of power links and a drain-to-source resistance, Rds_on, of replica columns. An input voltage may be monitored as an alternative. The monitoring compensates for changes in Rds_on due to changes in an input voltage, Vin, which could otherwise result in unstable behavior. The DLVR can avoid the complexity and power losses of dynamic biasing of the control gate voltages of the transistors.

### FIELD

The present application generally relates to the field of computing devices and more particularly to a digital linear voltage regulator (DLVR).

### BACKGROUND

Voltage regulators have various applications such as supplying power to components in an integrated circuit. For example, a voltage regulator may be used as a computer power supply that provides a stable direct current (DC) voltage used by a processor and other components of a computer. A voltage regulator typically includes a negative feedback control loop to automatically maintain a constant output voltage regardless of changes in the input voltage and the load. The voltage regulator can be digital or analog. Moreover, voltage regulators include linear regulators and switching regulators. However, various challenges are presented in operating voltage regulators.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1A depicts an example digital linear voltage regulator (DLVR) 100, in accordance with some embodiments.

FIG. 1B depicts an example implementation of the control circuit 110 of FIG. 1A, in accordance with some embodiments.

FIG. 2 depicts an example configuration of the power link 120 of FIG. 1A, in accordance with some embodiments.

FIG. 3 depicts an example plot of static loss versus input voltage for the DLVR 100 of FIG. 1A, in accordance with some embodiments

FIG. 4 depicts an analog equivalent scheme example of a single-zero, single pole (1Z1P) compensator circuit which explains a solution to the problem depicted in FIG. 3, in accordance with some embodiments.

FIG. 5 depicts an equation for a loop transfer function or gain of the circuit of FIG. 4, in accordance with some embodiments.

FIG. 6 depicts an example circuit for monitoring drain-to-source resistance, Rds_on for a stack of transistors in a power link, in accordance with some embodiments.

FIG. 7A depicts an example plot of the Q output of the flip-flop 640 of FIG. 6, in accordance with some embodiments.

FIG. 7B depicts example plots 710 and 720 of the voltages across CL and CR, respectively, in FIG. 6, in accordance with some embodiments.

FIG. 8A depicts an example implementation of the table 654 of FIG. 6 for setting for a percent of active power links based on an estimated Rds_on of replica columns, in accordance with some embodiments.

FIG. 8B depicts an example implementation of a table 850 for setting for a percent of active power links based on an error in Vin, in accordance with some embodiments.

FIG. 9 depicts an example table indicating a setting for an adjustment coefficient based on a calculated dropout value (DO), in accordance with some embodiments.

FIG. 10 depicts an example circuit 1000 for implementing the table of FIG. 9, in accordance with some embodiments.

FIG. 11A depicts an example digital linear voltage regulator (DLVR) 1100 which overcomes the problem depicted in FIG. 3, consistent with FIGS. 4 to 10, in accordance with some embodiments.

FIG. 11B depicts an example configuration of a Vin(t) monitoring circuit, for use in place of the Rds_on monitoring circuit 1150 of FIG. 11A, in accordance with some embodiments.

FIG. 11C depicts an example configuration of the power circuit 1115 of FIG. 11A, in accordance with some embodiments.

FIG. 11D depicts an alternative to the use of switches SW0 to SW7 in FIG. 11A, in accordance with some embodiments.

FIG. 12 illustrates an example of components that may be present in a computing system 1250 for implementing the techniques (e.g., operations, processes, methods, and methodologies) described herein, according to various embodiments.

### DETAILED DESCRIPTION

As mentioned at the outset, various challenges are presented in operating voltage regulators.

For example, the operation conditions of some Digital Linear Voltage Regulators (DLVR) feature a wide input voltage dynamic range. A DLVR may include transistors arranged in power stages. A DLVR, also known as a digital low-dropout regulator (DLDO), uses transistors controlled by a negative-feedback circuit to produce a specified output voltage that remains stable despite variations in load current and input voltage.

The transistors, also referred to as power transistors, can provide a power output based on a supplied input voltage and a control gate voltage. For example, the transistors may be p-type metal oxide silicon field effect transistors (MOSFETs) having a gate, drain and source. An input voltage, Vin, is supplied to the source while a control gate voltage is supplied to the gate, resulting in a current at the drain. The transistors can be arranged serially and/or in parallel paths to provide a combined current to a load. In one approach, the transistors are arranged in groups referred to as power links, where each power link has many columns of transistors, and there are one or more transistors per column. Control circuitry can be used to sense a voltage across the load and adjust the current from the transistors in a negative-feedback control loop.

However, variations in the input voltage, Vin, may reach several hundreds of millivolts (mV) and perhaps even exceed about 1 V. These variations can result in significant variations in the gate-to-source voltage, Vgs, of the power transistors, if no special care is taken. Consequently, the drain-to-source resistance, Rds_on, of the power transistors in the ON state changes, and hence, the loop gain changes. Changes in the loop gain may lead to unstable behavior of the voltage regulator, and a significant dependence of the power stage output impedance, Z(f) on the input voltage, resulting in an uncertainty in a controlled domain Vmin.

To cope with this problem, one possible solution involves dynamic biasing of the power transistors, in which the power transistors have a dynamically set control gate bias that changes in accordance with variations in the input voltage. In such a way, Vgs remains practically constant, irrespective of the value of Vin. Consequently, the loop gain variations are kept within an acceptable range.

However, the dynamic biasing solution has several drawbacks. For example, there is additional design complexity as it requires a unity gain buffer, re-referencing circuitry and more. Alternatively, an additional current mode “slow” loop may be designed. Additionally, there is an increase in the quiescent power of the DLVR, resulting in a power efficiency degradation and consequent performance loss. Finally, there is a significant area penalty degrading the utilization efficiency of the power stage.

Solutions disclosed herein address the above and other issues. The solutions observe that the loop gain of a DLVR depends on the effective value of Rds_on. This value depends on Vgs and the total count of switchable power transistors such as FETs. The solutions modulate the total effective driving strength of the switchable FETs in a way to compensate for changes in Vgs, thus reducing or removing the need for the above-mentioned dynamic biasing. This modulation can occurs at speed much lower than that of the main control loop—and, hence, does not interfere with regulation loop stability.

The solutions are particularly suitable for fully digital approaches, such as where the DLVR includes a power stage based on mixed stack FET structures, code rotation and similar.

The solutions enable a dynamic biasing-less DLVR design and avoids the related drawbacks as mentioned above. The solutions enable design simplification and potentially better time to market. Moreover, while there may be some added complexity due to the distribution of control signals, the associated complexity is much lower than that of an analog biasing design and validation. The solutions further enable a power-performance gain on the system-on-a-chip (SoC) or other circuit level, compared to the fixed power tax of dynamic biasing. As a result, if a SoC comprises numerous DLVRs, the power saved is multiplied accordingly. The solutions further enable leading process node silicon (Si) area savings.

In one aspect, a DLVR includes a power circuit having a set of power links, where each power link comprises a plurality of columns of transistors. Each column may include a single transistor, or multiple transistors connected serially. Additionally, the output voltage of the set of power links is regulated in two ways concurrently, while the transistors of the power links may receive a fixed bias such as a ground voltage. First, a digital code is generated based on an error of the output voltage relative to a target voltage. A decoder converts the digital code into control signals to activate (turn on) or inactivate (turn off) individual columns of transistors in each power link. These control signals may be the same for each set of power links, in one approach. Second, a logic circuit provides control signals to activate or inactivate entire power links. These control signals can be based on monitoring Rds_on and/or a dropout voltage of the set of power links. A feedback control loop of the first regulation may be faster than a feedback control loop of the second regulation.

The above and other advantages will be further apparent in view of the following discussion.

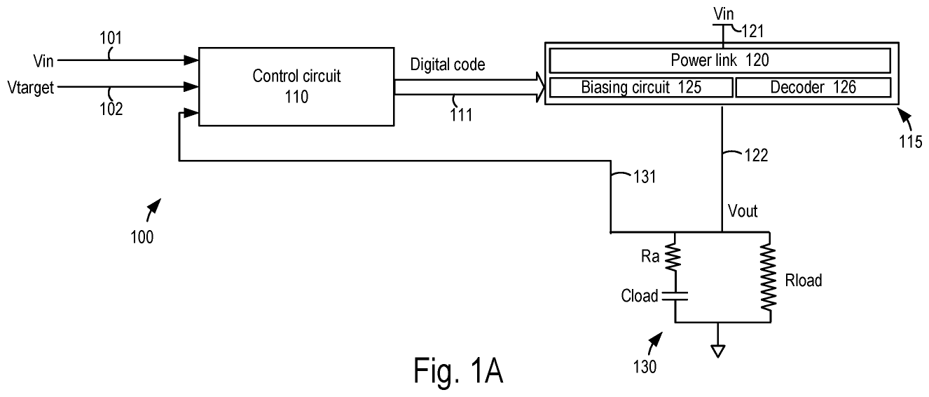

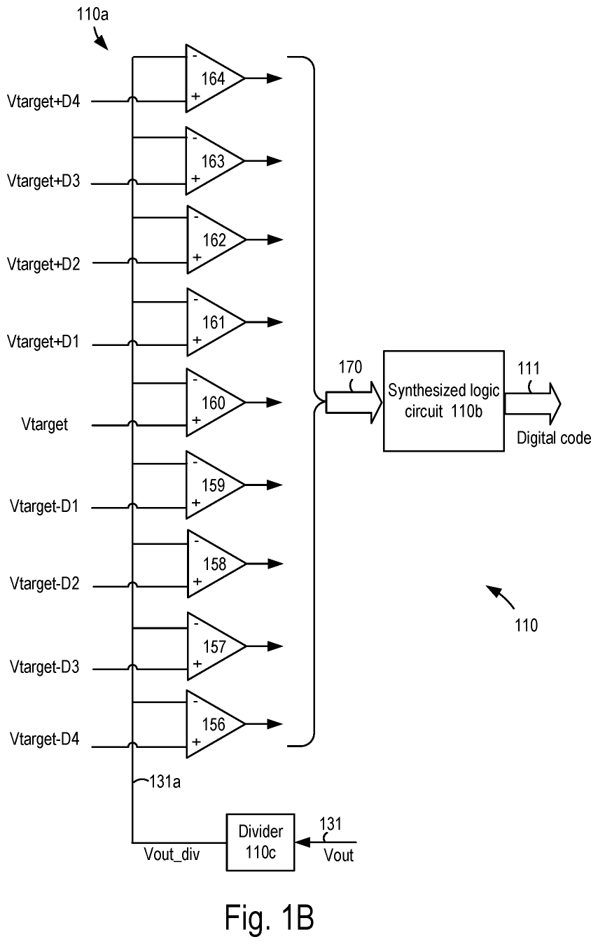

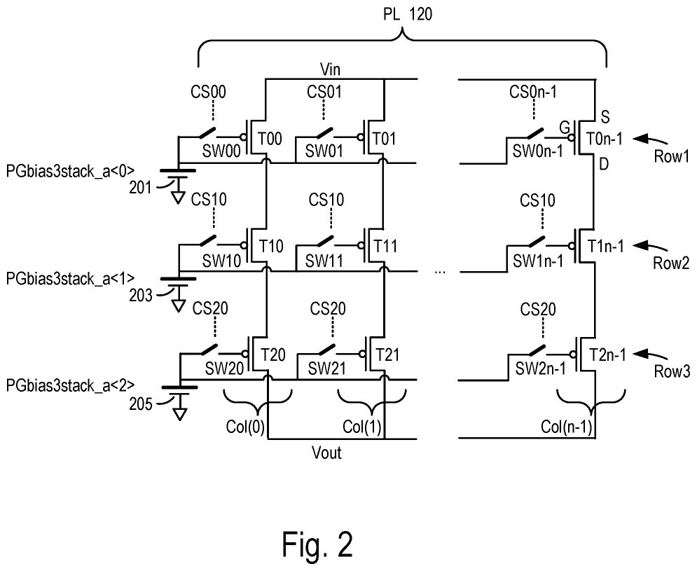

FIG. 1A depicts an example digital linear voltage regulator (DLVR) 100, in accordance with some embodiments. The DLVR includes a control circuit 110, which receives an input voltage, Vin, on a path 101, a target voltage, Vtarget, on a path 102, and a sensed voltage, Vout, on a path 131. Based on a difference between Vout and Vtarget, the control circuit provides a digital code, e.g., a digital requested current output, as an output on a path 111 to a power circuit 115. Vtarget is a desired level of Vout. The power circuit includes a single power link 120. The power link (PL) includes columns of transistors, where one or more transistors are provided in each column, also referred to as a leg. When multiple transistors are in a column, they may be serially connected, such as depicted in FIG. 2. The power link is biased by Vin at a power supply node 121.

The power circuit further includes a biasing circuit 125 and a decoder 126. The biasing circuit is for applying a variable control gate bias to transistors in the PL based on the digital code, and the decoder is for activating or inactivating individual columns in the PL based on the digital code. The decoder may provide control signals to switches associated with the transistors to open or close the switches. An open switch does not conduct while a closed switch does conduct. The decoder 126 may perform a binary to thermometer decoding to provide the control signals. For example, a nine-bit binary code word can be decode to a 512 bit long bit string, where each bit controls the on/off state of a respective column of the PL. For example, the first bit may control the on/off state of a first column, the second bit may control the on/off state of a second column, and so forth. Based on the control gate bias and the columns which are turned on, or active, the current output of the PL can be adjusted in a control loop.

The power circuit 115 provides an output current, Iout, which results in a voltage, Vout, on a path 122, and across a load 130. The load 130 in this example is represented by a load resistance, Rload, in parallel with a series-connected resistor, Ra, and capacitor, Cload. A feedback path 131 couples the output voltage, Vout, to the control circuit 110 to implement a negative-feedback control loop which tends to stabilize Vout. The control loop is to regulate Vout, or a divided version of Vout, at Vtarget.

FIG. 1B depicts an example implementation of the control circuit 110 of FIG. 1A, in accordance with some embodiments. The control circuit may include an analog-to-digital converter (ADC) 110a, a synthesized logic circuit 110b and a divider 110c, The ADC can be implemented in many architectures (e.g., FLASH, SAR, PIPE etc.). For example, a FLASH architecture is illustrated. It includes a number of comparators 156-164. The comparators map an analog voltage error to a digital code for use by the synthesized logic circuit 110b. The synthesized logic circuit is one example implementation. Another example is a digital signal processor (DSP).

Vout on the path 131 may be divided by a divider circuit 110c to provide a divided down voltage, Vout_div on a path 131a. Each comparator receives Vout_div on the path 131a at an inverting input and a different target or reference voltage at a non-inverting input. For example, the central comparator 160 may receive Vtarget, which is the desired voltage to which Vout_div should equal. That is, the control circuit implements a feedback loop to have Vout_div match Vtarget. The comparators above the central comparator receive voltages higher than Vtarget while the comparators below the central comparator receive a voltages lower than Vtarget. For example, comparators 161, 162, 163 and 164 may receive Vtarget+Δ1, Vtarget+Δ2, Vtarget+Δ3 and Vtarget+Δ4, respectively, and comparators 156, 157, 158 and 159 may receive Vtarget−Δ4, Vtarget−Δ3, Vtarget−Δ2 and Vtarget−Δ1, respectively, where Δ1<Δ2<Δ3<Δ4. Each comparator outputs a high voltage if the reference voltage is greater than Vout_div. Otherwise, it outputs a low voltage.

The comparators can be voltage mode amplifiers in an open loop configuration, such that their output voltages are railed high or low, depending on the voltages at their inputs. Other implementations (e.g., switched comparator) are possible. Their outputs can be routed in parallel on a digital bus 170 and read in by the synthesized logic circuit 110b as a 9-bit thermometer encoded word, for example. The #of bits is not critical and can be any number, depending on system requirements.

The error of Vout_div can therefore be classified into one category among multiple categories based on a code on the digital bus 170. For example, in this example, there are ten categories: less than −Δ4, −Δ4 to −Δ3, −Δ3 to −Δ2, −Δ2 to −Δ1, −Δ1 to 0, 0 to Δ1, Δ1 to Δ2, Δ2 to Δ3, Δ3 to Δ4 and greater than Δ4. If Vout_div is between Vtarget−Δ2 and Vtarget−Δ3, the comparator outputs are 110000000. As another example, if Vout_div is between Vtarget+41 and Vtarget+42, the digital code is 111111000.

The 9-bit code on the digital bus 170 is thus a digital error signal indicating an error c(t) of Vout. A goal of the synthesized logic circuit is to set a gain of a control loop which minimizes this error signal. This process includes updating a digital code which is provided on the path 111 to the decoder 126 in the power circuit, to provide an appropriate amount of current to minimize the error. If Vout_div<Vtarget, the code is increased to increase the resistance of the power stage and if Vout_div>Vtarget, the code is decreased to decrease the resistance. The digital code may also account for a voltage dropout.

FIG. 2 depicts an example configuration of the power link 120 of FIG. 1A, in accordance with some embodiments. The PL includes a number “n” of columns, Col(0), Col(1), . . . . Col(n−1), where n is an integer which is typically a power of two. The columns are connected in parallel to one another. Moreover, each power link has a triple-stack configuration in this example, which means there are three serial-connected power transistors in each column. Generally, one or more power transistors can be provided in each column. The number “n” can be 256 or 512, for example, where the digital code has 8 or 9 bits, respectively. For example, Col(0) includes series-connected power transistors T00, T10, . . . . T20, Col(1) includes series-connected power transistors T01, T11 . . . . T21, and Col(n−1) includes series-connected power transistors T0n−1. T1n−1, . . . . T2n−1.

Each transistor is in a row which has an available dynamically adjustable voltage source. In this example, a switch is provided for each transistor in a row to connect or disconnect the transistor from the voltage source 201. The transistors in a row may have a common control gate voltage source, in one approach. For example, the control gates of T00, T01, . . . T07 are coupled to a voltage source 201 with a bias PGbias3stack_a<0>, the control gates of T10, T11, . . . T17 are coupled to a voltage source 203 with a bias PGbias3stack_a<1>, and the control gates of T20, T21, . . . T27 are coupled to a voltage source 205 with a bias PGbias3stack_a<2>. PG denotes a power gate or transistor. The dynamic biases may be controlled by the biasing circuit 125.

Additionally, switches may be provided to couple or decouple the control gate of each transistor from a bias voltage. The switches themselves may also be transistors, referred to as column transistors, in contrast to the power transistors which generate current to provide Vout. For example, column switches SW00, SW01, . . . , SW07 are associated with power transistors T00, T01 . . . . T07, respectively, and controlled by column switching signals CS00, CS01, . . . , CS0n−1, respectively. Column switches SW10, SW11, . . . , SW1n−1 are associated with power transistors T10, T11, . . . T1n−1, respectively, and controlled by column switching signals CS10, CS11, . . . CS1n−1, respectively. Column switches SW20, SW21, . . . , SW2n−1 are associated with power transistors T20, T21, . . . T2n−1, respectively, and controlled by column switching signals CS20, CS21, . . . , CS2n−1, respectively. Each power transistor may be independently turned on or off in the PL.

The power transistors are pMOSFETs in this example, where each transistor includes a gate (G), a source (S) and a drain (D) such as depicted for the transistor T07. A pMOSFET is turned on when Vgs>Vth.

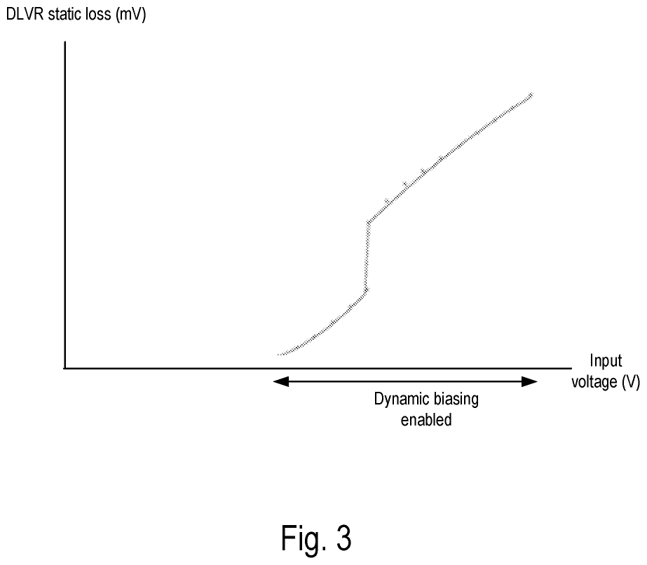

FIG. 3 depicts an example plot of static loss versus input voltage for the DLVR 100 of FIG. 1A, in accordance with some embodiments. The vertical axis depicts total DLVR static losses for a multi-domain central processing unit (CPU) as function of the input voltage, Vin. There is a strong increase in the loss that is observed when dynamic biasing is enabled. This is a step-like increase in quiescent power that is associated with invocation of dynamic biasing. By avoiding dynamic biasing using the solutions described herein, static loses can be reduced.

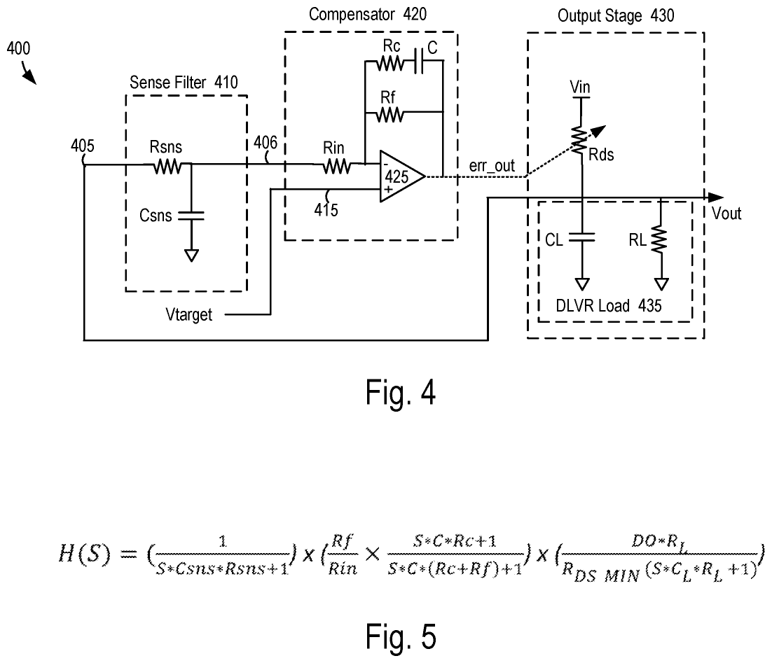

FIG. 4 depicts an analog equivalent scheme example of a single-zero, single pole (1Z1P) compensator circuit 400 which explains a solution to the problem depicted in FIG. 3, in accordance with some embodiments. A 1Z1P circuit is depicted as an example only, as the solution is applicable to other types of control loops as well. An analog equivalent scheme of the circuit under discussion is presented.

The circuit 400 includes a sense filter 410, a compensator 420 and an output stage 430. The compensator includes an error amplifier 425 and can be implemented digitally, while the output stage or power stage includes power gates and also can be implemented digitally. The sense filter includes a resistor, Rsns, coupled to a path 405 which carries the output voltage, Vout, as a feedback voltage. The path is coupled to ground via a capacitor, Csns. The output of the sense filter is provided on a path 406 to the compensator 420. The compensator includes a resistor, Rin, coupled to an inverting input of an amplifier 425. A non-inverting input of the amplifier receives the target voltage, Vtarget on a path 415. The output of the amplifier, err_our, an error signal, is fed back to the inverting input via two parallel paths, including a first path which includes a resistor, Rc, and a capacitor, C, in series, and a second path which includes a resistor, Rf.

In the output stage 430, the error signal, err_out, is used to adjust the resistance, Rds, which represents a drain-to-source voltage of the power transistors. Rds is biased by an input voltage, Vin, and provides the output voltage, Vout to a DLVR load 435. The load is represented by a capacitor, CL, in parallel with a resistance, RL.

The voltage Vout=Rds/(Rds+RL)×Vin. RL will change over time due to changes in the load. For example, if the load is a processor core, RL will vary as the processor core executes different tasks. Additionally, Vin is constantly changing due to changes in the current consumption of the load. Vin=VID−Icc(t)*Rext, where VID is the voltage output of a voltage regulator of the mother board, Icc(t) is the current of the load, and Rext is the external load line resistance.

As a result, Rds has to change to maintain a desired target Vout, e.g., 1 V. Vin is at a higher level than Vout and may be 2 V, for example. In one option, Rds can be changed by changing the number of columns of transistors which are turned on. The compensator can operate on a fast cycle to determine the number of columns to be turned on or off to keep Vout constant. It can be assumed that each column has the same resistance. However, the Rds_on of a pMOSFET depends on its biasing. In a further option, as described herein, Rds_on can be changed by providing multiple power links and activating or inactivating selected power links.

FIG. 5 depicts an equation for a loop transfer function or gain H(S) of the circuit 400 of FIG. 4, in accordance with some embodiments. In H(S), the first, second and third bracketed expressions represent the contributions of the sense filter, the compensator, and the output stage, respectively. RL and CL stand for the capacitance of the load domain and its current, while Rds_min is the effective resistance of all switchable transistors of the DLVR power stage.

DO represents the power stage dropout or headroom, e.g., Vin_nom−Vout_nom. Vin_nom and Vout_nom represent expected values of the input and output voltages, respectively, disregarding transients due to fast load current changes.

As evident from the equation, the loop gain increases as DO increases, and decreases as Rds_min increases. Rds_min is roughly proportional to [VIN−VT] (in a linear regime, assuming Vin to Vss switching). VT is a threshold voltage. Usually, Vin_nom−Vout_nom<Vin−VT. Thus, for values of DOs smaller than a certain critical threshold value, DOth, an increase in Vin and a subsequent reduction in Rds_min does not pose a risk to loop stability. On the other hand, for DO>DOth, regulation implies that only a portion of the power stage (PS) transistors, e.g., pMOSFETs, is required to be able to conduct. In other words, under relatively high DO conditions, the power stage may contain a substantial number of redundant transistors. Note that frequently PS is sized to meet electro-migration requirements in a low DO regime (e.g., bypass or power gate mode).

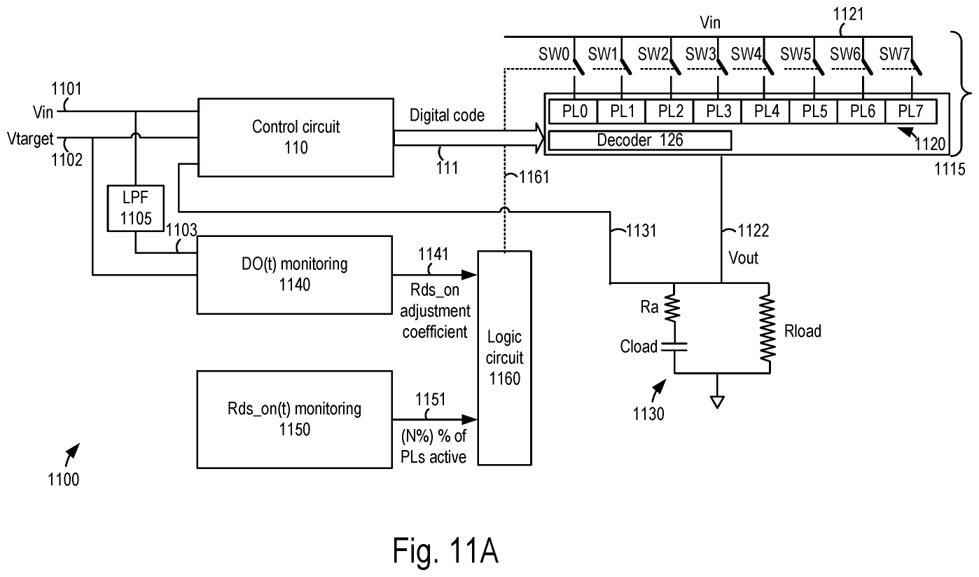

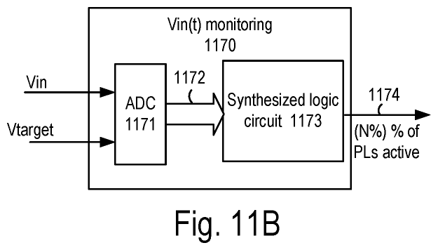

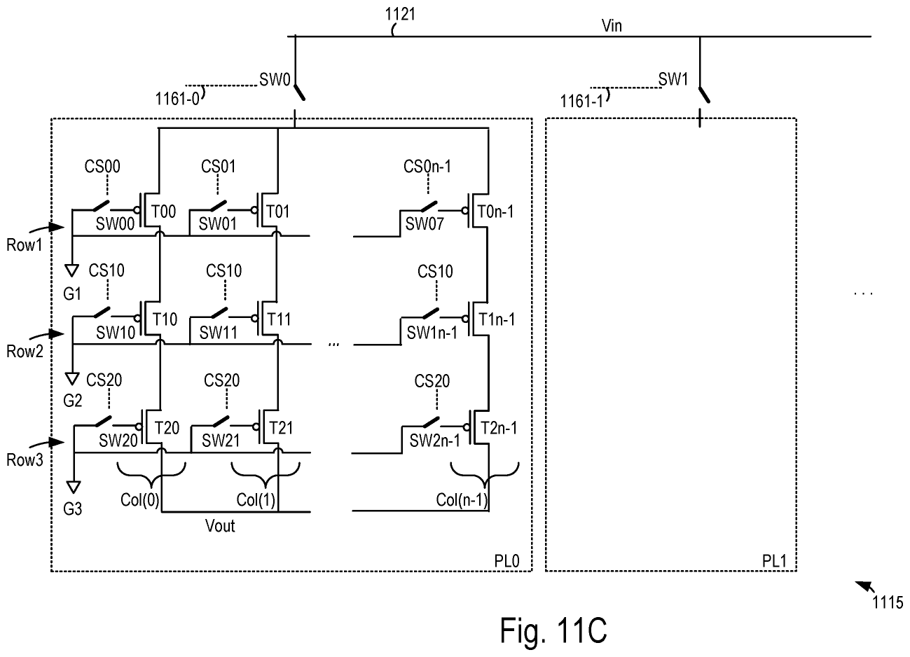

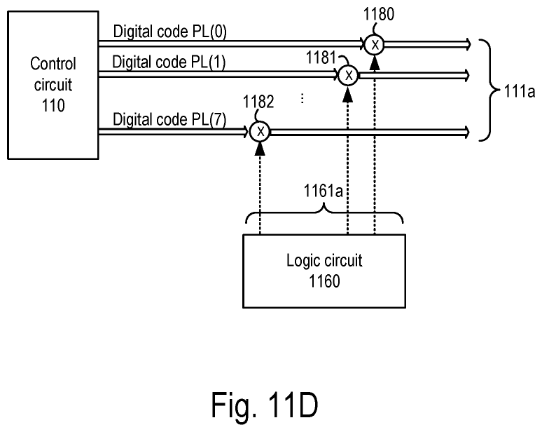

As discussed, the power circuit can be divided into numerous smaller building blocks, also known as power links (PL). See power links PL0 to PL7 in FIG. 11A, for example. In this case, Rds_min can be written in the following form:

Rds_min=Rds_fet(Vgs)/[effective number of transistors per PL*number of PLs].

Rds_fet(Vgs) represents the effective resistance of a single transistor and depends on Vgs. When, as described above, Vin and, consequently Vgs increase, Rds_FET decreases. To mitigate the corresponding reduction in Rds_min, and keep the loop gain below a level which critical for loop stability, it is proposed to switch off a portion of the power links that form the DLVR power stage. This action is to be taken if the current DO is higher than DOth, when the power stage is not EM limited, as discussed above.

The proposed approach relies on real-time monitoring of the DO(t) value and of either Vin(t) or Rds_on(t). Both options are possible. For the sake of simplicity and without loss of generality, details of a proposed architecture are provided using Rds_on monitoring and two-bit bucketing of DO(t). A possible implementation of an Rds_on monitoring circuit is discussed below. There are numerous alternative implementations possible.

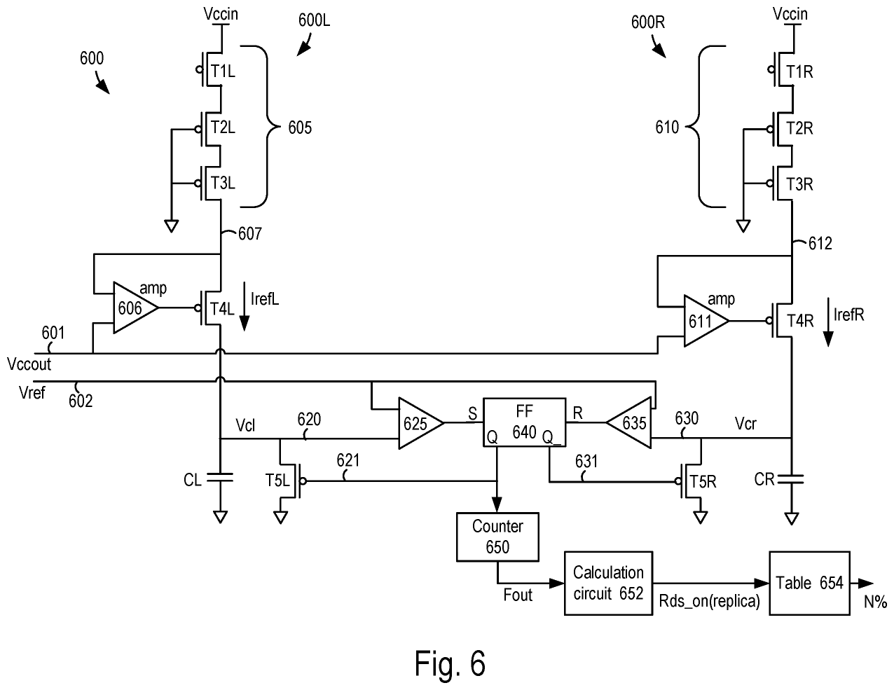

FIG. 6 depicts an example circuit for monitoring Rds_on for a stack of transistors in a power link, in accordance with some embodiments. The circuit 600 includes a local oscillator to monitor Rds_on. The circuit includes mirror image left and right hand sides 600L and 600R, respectively. Each side includes identical PLs, which are replicas of the transistors in the power links in the power stage. For example, the left hand side 600L includes a power link 605, including serially-connected transistors T1L, T2L and T3L, which are biased with Vccin. The power links have three-stages or transistors in this example, but other approaches are possible. The voltage output from the PL 605 is provided on a path 607 which is coupled to the source of a transistor T4L and to an input of an amplifier 606 (amp) whose output drives a control gate of T4L. Vccout on a path 601 is an additional input to the amplifier 606. A reference current, IrefL, is therefore generated in T4L.

Similarly, the right hand side 600R of the circuit 600 includes a power link 610, including serially-connected transistors T1R, T2R and T3R, which are biased with Vccin. The voltage output from the PL 610 is provided on a path 612 which is coupled to the source of a transistor T4R and to an input of an amplifier 611 whose output drives a control gate of T4R. Vccout is an additional input to the amplifier 611. A reference current, IrefR, is therefore generated in T4R.

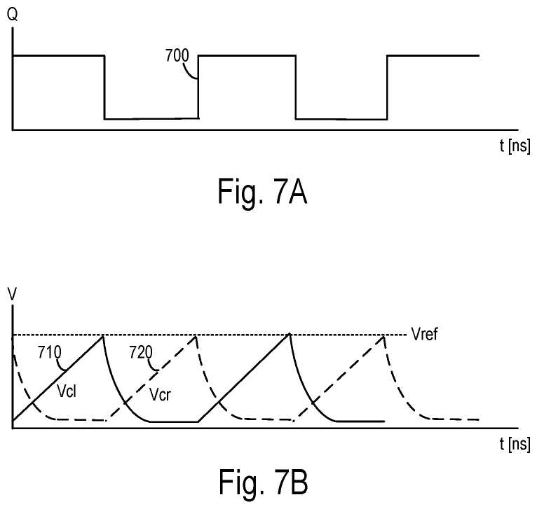

IrefL results in a voltage Vcl across a capacitor CL at a path 620, and IrefR results in a voltage Vcr across a capacitor CR at a path 630. The path 620 is coupled to the source of a transistor T5L and to a comparator 625, while the path 630 is coupled to the source of a transistor T5R and to a comparator 635. An additional input to the comparators is Vref on path 602, where Vref<Vccout. Based on the respective inputs, the comparators 625 and 635 output a high or low value to a flip-flop (FF) 640. In one approach, the flip-flop is a set-reset type which includes a set (S) input coupled to the output of the comparator 625 and a reset (R) input coupled to the output of the comparator 635. The flip-flop includes an output Q and a complementary output Q_. The output Q is coupled on a path 621 to the control gate of a transistor T5L which grounds the path 620 when Q is low. The output Q_ is coupled on a path 631 to the control gate of a transistor T5R which grounds the path 630 when Q_ is low. Q is also coupled to a counter 650, which can provide a corresponding output frequency, Fout, based on a switching frequency of Q, as explained further in connection with FIGS. 7A and 7B. In operation, the circuit will alternate between Q=high and Q=low.

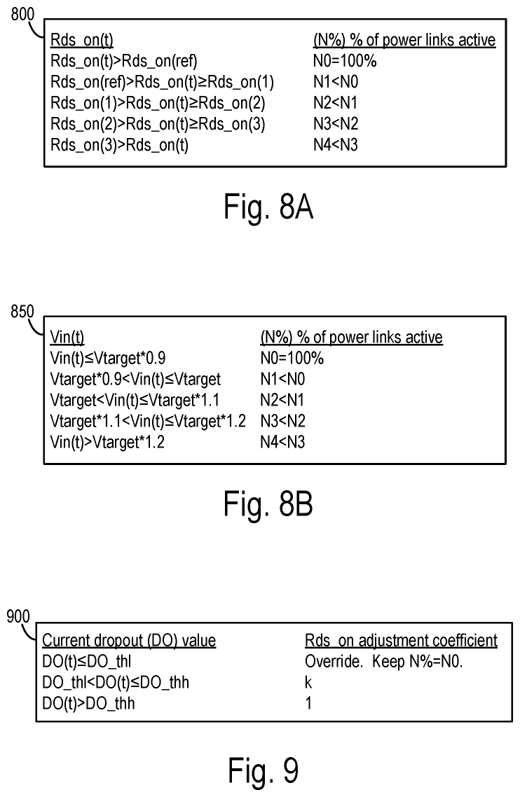

Fout can be provided to a calculation circuit 652, which outputs Rds_on(replica) to a table 654, which in turn outputs a value N %, a percent of power links which should be active. See FIG. 8A.

The calculation circuit 652 may operate as follows. Since the frequency Fout=Iref/(C*Vref) and Iref=(Vccin−Vccout)/Rds_on(replica), Rds_on(replica)=(Vccin−Vccout)/(C*Fout*Vref), and C=CR=CL. N % is a percentage of the power links in the power stage to be switched on, as a function of Rds_on (or Vin). This percentage can be simulated pre-Silicon and characterized and validated post-Silicon, e.g., with the circuit fabricated on a silicon chip. The results can be arranged in the table 654 (e.g., in an array or fuses), such as discussed below in connection with FIG. 8A.

FIG. 7A depicts an example plot 700 of the Q output of the flip-flop 640 of FIG. 6, in accordance with some embodiments. The vertical axis depicts a voltage at the Q output and the horizontal axis depicts time, e.g., on a nanosecond (ns) scale. Q will alternate between high and low values according to a current and capacitance value of the circuit 600.

FIG. 7B depicts example plots 710 and 720 of the voltages across CL and CR, respectively, in FIG. 6, in accordance with some embodiments. The solid-line plot 710 depicts Vcl and the dashed-line plot 720 depicts Ver. The capacitor CL will charge up linearly based on the current on the path 607 as long as the transistor T5L is not grounding the path 620. When Vcl reaches Vref, the output of the comparator 625 switches, so that Q switches from high to low. This causes T5L to switch from an off (non-conductive) to an on (conductive) state, grounding the path 620 and causing CL to discharge. When CL is charging up, Q is high so that Q_ is low, and T5R is on, grounding the path 630 and discharging CR.

Once Q_ switches to high, CR can charge up. The capacitor CR will charge up linearly based on the current on the path 612 as long as the transistor T5R is not grounding the path 630. When Vcr reaches Vref, the output of the comparator 635 switches, so that Q_ switches from high to low. This causes T5R to switch from off to on, grounding the path 630 and causing CR to discharge.

FIG. 8A depicts an example implementation of the table 654 of FIG. 6 for setting for a percent of active power links based on an estimated Rds_on of replica columns, in accordance with some embodiments. In the table 800, the first column indicates Rds_on(t), which is a time-varying value of Rds_on(replica), and the second column indicates N %, a percent of power links which should be active based on Rds_on(t). The table classifies Rds_on(t) into one of five contiguous ranges, as an example.

In a first range, Rds_on(t)>Rds_on(ref), and the corresponding value of N % is N0=100%. This indicates all power links are to be turned on. In a second, next lower range, Rds_on(ref)>Rds_on(t)>Rds_on(1), and the corresponding value of N % is N1<NO. In a third, next lower range, Rds_on(1)>Rds_on(t)>Rds_on(2), and the corresponding value of N % is N2<N1. In a fourth, next lower range, Rds_on(2)>Rds_on(t)>Rds_on(3), and the corresponding value of N % is N3<N2. In a fifth, next lower range, Rds_on(t)<Rds_on(3), and the corresponding value of N % is N4<N3. The values Rds_on(ref), Rds_on(1), Rds_on(2) and Rds_on(3) can be optimized through simulations and testing. Essentially, as the simulated value of Rds_on decreases, the portion of the power links which are turned on decreases. In other words, an increasing number of power links are turned off as Rds_on decreases. When power links are turned off, the total current decreases. As a result, Rds increases since R=V/I according to Ohm's law.

The table thus provides a mapping between a pre-calculated/measured Rds_on and N %. Note that N % can be replaced by an actual number of PL to turn on. For example, assuming a power stage with eight PLs, N0=8, N1=7, N2=6, N3=5 and N4=4 in one possible approach.

FIG. 8B depicts an example implementation of a table 850 for setting for a percent of active power links based on an error in Vin, in accordance with some embodiments. See also FIG. 11B. The table cross-references different ranges of V(t) to different value of N %, a percent of power links active. As mentioned in connection with FIG. 11B, Vin(t) can be compared to different thresholds above and below Vtarget to determine a range of voltages in which Vin(t) falls.

In this example, in a first range, Vin(t)≤Vtarget, and the corresponding value of N % is N0=100%. In a second, next higher range, Vtarget*0.9<Vin(t)≤Vtarget, and the corresponding value of N % is N1<NO. Thus, a reduced number of PLs are turned on. In a third, next higher range, Vtarget<Vin(t)≤Vtarget*1.1, and the corresponding value of N % is N2<N1. In a third, next higher range, Vtarget*1.1<Vin(t)≤Vtarget*1.2, and the corresponding value of N % is N3<N2. In a fourth, highest range, Vin(t)>Vtarget*1.2, and the corresponding value of N % is N4<N3.

Essentially, as Vin(t) increases, the portion of the power links which are turned on decreases. In other words, an increasing number of power links are turned off as Vin(t) increases. When power links are turned off, the total current decreases. As a result, Vin(t) decreases since V=IR according to Ohm's law. Similarly, as Vin(t) decreases, the portion of the power links which are turned on increases.

FIG. 9 depicts an example table 900 indicating a setting for an adjustment coefficient based on a calculated dropout value (DO), in accordance with some embodiments. A final decision on the required number of PLs to activate depends on both the current Rds_on(t) for a PL as per FIG. 8A (or Vin(t) per FIG. 8B) as well as the current DO(t) value. The expected impact of the DO can also be characterized pre- and post-Silicon and stored in the table 900.

A first column of the table depicts a current, e.g., present, dropout (DO) value. The second column depicts a corresponding adjustment coefficient. In this example, there are three buckets or ranges for DO(t).

In a first range, DO(t)≤DO_thl, where DO_thl is a lower threshold voltage. A corresponding action is to override any change in N % and keep it at NO. Thus, any change due to table 800 is overridden, in one possible approach. In this case, when the dropout voltage is less than a lower threshold dropout voltage, the second output/adjustment coefficient indicates the number of power links to turn on is to be overridden so that all of the power links are turned on.

In a second, next higher range, DO_thl<DO(t)≤DO_thh. DO_thh is an upper threshold voltage, greater than DO_thl. A corresponding action is to set the adjustment coefficient to a value k, where 0<k<1. Thus, k is a fraction less than one. In this case, N % as determined by table 800 or 850 can be reduced by multiplying by k. Accordingly, when the dropout voltage is between a lower threshold dropout voltage and an upper threshold dropout voltage, the second output/adjustment coefficient indicates the number of power links indicated by the first output is to be reduced.

In a third, highest range, DO(t)>DO_thh. A corresponding action is to set the adjustment coefficient to one. In this case, N % as determined by table 800 or 850 is unchanged since it is multiplied by one. Accordingly, when the dropout voltage is greater than an upper threshold dropout voltage, the second output/adjustment coefficient indicates the number of power links indicated by the first output is not to be changed or overridden.

This is merely one example implementation as other implementations are possible. Note also that it is possible to combine tables 800 or 850 and 900 into one table with three columns. With tables 800 and 900 combined, the first column may be for Rds_on(t), the second column may be for DO and the third column may be for N %. With tables 850 and 900 combined, the first column may be for Vin(t), the second column may be for DO and the third column may be for N %.

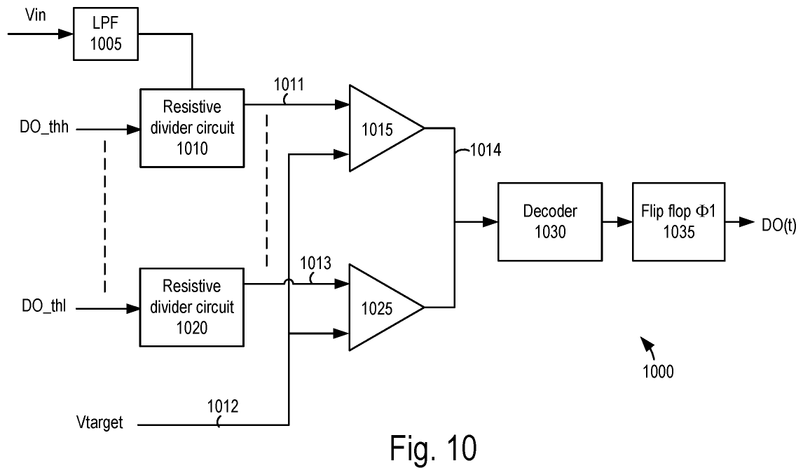

The table 900 thus provides per-DO bucket adjustment coefficients. An example of a DO bucketing scheme realization is provided in FIG. 10.

FIG. 10 depicts an example circuit 1000 for implementing the table of FIG. 9, in accordance with some embodiments. The circuit includes a resistive divider 1010 which receives Vin after it passes through a low pass filter (LPF) 1005. The resistive divider 1010 also receives DO_thh. An output of the resistive divider 1010 on a path 1011 is compared to Vtarget on the path 1012 at a first comparator 1015. The circuit further includes a resistive divider 1020 which receives DO_thl. An output of the resistive divider 1020 on a path 1013 is compared to Vtarget on the path 1012 at a second comparator 1025. The comparators provide an output on a path 1014 to a decoder 1030, which converts the input from thermometer code to binary code. The output of the decoder 1030 is provided to a single-phase flip-flop 1035, which in turn provides the output DO(t) for use in the table 900.

This is a flash ADC based realization of DO(t) bucketing. Actual Rds_on(t) and DO(t) values serve as addresses for data in the tables 800 and 900, respectively. The retrieved percentage of active power links and the adjustment coefficients can be retrieved and used by a DLVR internal logic, without involving p-code, in one approach.

One possible implementation of a DLVR based on the above discussion is provided in FIG. 11A.

FIG. 11A depicts an example digital linear voltage regulator (DLVR) 1100 which overcomes the problem depicted in FIG. 3, consistent with FIGS. 4 to 10, in accordance with some embodiments. In contrast with the circuit of FIG. 1A, the circuit 1100 includes a logic circuit 1160, a DO(t) monitoring circuit 1140 (a second monitoring circuit), an Rds_on(t) monitoring circuit 1150 (a first monitoring circuit), and a set 1120 of power link switches SW0 to SW7 coupled to PL0 to PL7, respectively. In particular, the control circuit is a main control of the DLVR, and may be provided as a compensator of adaptive transfer function, for example. The control circuit 110, path 111 and decoder 126 of FIG. 1A are repeated here as these components advantageously need not be modified.

The main control 110 outputs a digital code on a path 111 to a power circuit 1115 based on Vtarget on a path 1102 and Vout on a path 1131. The digital code represents a requested current output from the power circuit by specifying columns of transistors to turn on in each power link. Vin is also provided as a power source on a path 1101 but the dropout is not calculated by the control circuit 110, in one approach. The control circuit 110 implements a control loop to keep Vout equal to Vtarget, where Vin>Vtarget.

The Rds_on(t) monitoring circuit includes the table 800 and the circuit 600 and outputs the value N % (a first output) to the logic circuit on a path 1151.

The DO(t) monitoring circuit 1140 includes the table 900 and the circuit 1000 and outputs an adjustment coefficient (a second output) to the logic circuit 1160 on a path 1141 in response to a low-pass filtered version of Vin on a path 1103 (via the LPF 1105) and Vtarget. The DO(t) monitoring circuit monitors the dropout voltage of the set of power transistors by monitoring a difference between Vin and Vtarget, where Vtarget is the target value for Vout.

The logic circuit 1160 processes the inputs to provide a respective control signal on a path 1161 to each switch of the set of PL switches SW0 to SW7 to independently open (make non-conductive) or close (make conductive) each switch and thereby make active or inactive, respectively, each respective PL. The path 1161 may represent multiple separate paths, one for each PL switch. See also FIG. 11C. The PL switches which are closed pass Vin on a power supply node 1121 to a respective set of columns of power transistors, so that the respective PL provides an output current on the path 1122 which is combined with the output current of other active PLs. The total output current is a sum of the currents from the active PLs. The PL switches which are open do not pass Vin to the respective PL, so that the respective PL does not provides an output current on the path 1122. For an active PL, the amount of current passed is a function of the number of columns of transistors turned on, according to the control signals from the decoder 126. The decoder may decode binary data of the digital code to provide thermometer coded data, where each respective bit is provided in a respective control signal to indicates whether a respective column of a PL is to be turned on or off.

For example, the logic circuit may set a number of active PLs at 100% if the adjustment coefficient is set to override. The logic circuit may set a number of active PLs based on N % and k if the adjustment coefficient is k. For example, N % may be 80% and k=0.7, in which case 80% x 0.7=56% of the PLs are turned on. For example, with eight PLs, 56% of 8 is 4 or 5 depending on the rounding off. The logic circuit may set a number of active PLs based on N % if the adjustment coefficient is 1. Other variations are possible.

The decoder 126 controls which power transistors/columns are turned on or off in each PLs, in response to the digital code, as discussed previously. The output voltage, Vout, on a path 1122 is provided to a load 1130, represented by Rload in parallel with Ra and Cload.

The circuit 1100 provides a high level, conceptual scheme of a DLVR with automatic adjustment of active power links. Based on the monitored values DO(t) and Rds_on(t), the DLVR internal logic decides on the number of active power links. The control loops of the monitoring circuits 1140 and 1150 for adjusting the number of active PLs can be substantially slower than the main control loop of the control circuit 110. Hence, the compensator operation is undisturbed, and its output code continues to be respective to the error signal e(t). Changes in the number of active power links manifest themselves similarly to load set/load release events.

In one option, the monitoring circuit 1150 monitors Vin instead of Rds_on. In this case, Vin on the path 1101 and Vtarget on path 1102 are provided an input to a monitoring circuit. See FIG. 11B for an example.

Implementation details of merging between the compensator output and the output of the “active PL” decision logic block depend on an actual implementation of the control decoding and distribution.

In one aspect, the respective control signals on the path 1161 compensate for changes in a drain-to-source resistance of the set of power links, e.g., by compensating for changes in a drain-to-source resistance of one or more replica transistors of the set of power links.

In one aspect, the respective control signals compensate for changes in an input voltage of the set of power links.

In one aspect, the control circuit 110 is to provide the digital code based on a difference between an output voltage of the set of power links and a target voltage.

In one aspect, the second monitoring circuit 1140 is to provide the second output based on a difference between the target voltage and a low-pass filtered version of the input voltage.

In one aspect, a control loop of the logic circuit 1160 and the respective control signals on the path 1161 is slower than a control loop of the control circuit 110 and the digital code on the path 111.

FIG. 11B depicts an example configuration of a Vin(t) monitoring circuit 1170, for use in place of the Rds_on monitoring circuit 1150 of FIG. 11A, in accordance with some embodiments. As mentioned, an option to monitoring Rds_on is to monitor Vin(t), a time varying level of Vin. Vin changes due to changes in the load resistance, and these changes can be detected by comparing Vin, or a divided version of Vin, to Vtarget, for example. The monitoring circuit 1170 can detect a level of Vin relative to different thresholds at an ADC 1171, similar to the ADC 110a of FIG. 1B, for example. In one approach, the output on the digital bus 170 is provided on the digital bus 1172 to a synthesized logic circuit 1173 so that a separate ADC 1171 is not used. Although, it may be desired to use different thresholds and/or a different numbers of thresholds here than in the case of the ADC 110a. See also FIG. 8B for example thresholds for Vin(t). The synthesized logic circuit 1173 in turn provides an output of N % on a path 1174.

FIG. 11C depicts an example configuration of the power circuit 1115 of FIG. 11A, in accordance with some embodiments. The set of power links PL0, PL1 . . . , PL7 are part of a power stage. The arrangement of power transistors and their respective switches may be similar to that of FIG. 2. This arrangement includes the power transistors T00, T10 and T20 in Col(0), power transistors T01, T11 and T21 in Col(1), and power transistors T0n−1, T1n−1 and T2n−1 in Col(n−1).

However, here, each row of power transistors is associated with a fixed voltage source, e.g., a ground voltage. For example, Row1, Row2 and Row3 are associated with ground nodes G1, G2 and G3, respectively. In Row1, a power transistor receives the ground bias if a respective switch is closed. For example, if SW00, SW01 . . . , SW07 are closed by column control signals CS00, CS01 and CS0n−1, respectively, the control gates of the associated transistors are coupled to the ground G1. In Row2, if SW10, SW11 . . . , SW17 are closed by column control signals CS10, CS11 and CS1n−1, respectively, the control gates of the associated transistors are coupled to the ground G2. In Row3, if SW30, SW31 . . . , SW37 are closed by column control signals CS20, CS21 and CS2n−1, respectively, the control gates of the associated transistors are coupled to the ground G3.

Optionally, some of the rows, e.g., Row2 and Row3, can omit the switches and hard wire the control gates of the transistors to the corresponding ground voltage.

When the power transistors are pMOSFETs, the current is larger when the control gate bias is smaller, for a given source voltage (e.g., Vin). In other words, the current is larger when the gate-to-source voltage is smaller.

Additionally, as mentioned, the PL switches SW0 to SW7 control whether the respective PLs are active. For example, PL0 includes the switch SW0 controlled by a control signal from the logic circuit on a respective path 1161-0, PL1 includes the switch SW1 controlled by a control signal from the logic circuit on a respective path 1161-1 . . . and so forth.

As mentioned, the column control signals can be provided by the decoder based on the digital code received from the control circuit 110. These column control signals can be adjusted as the digital code is adjusted when the power links are turned on or off by the logic circuit. For example, if one or more PLs are newly turned off, the output current on the path will decrease temporarily. The control circuit will sense a decrease in Vout and adjust its digital code accordingly to increase the current output of the remaining turned on power links. This can involve turning on a larger number of columns within each PL.

If one or more PLs are newly turned on, the output current on the path will increase temporarily. The control circuit will sense an increase in Vout and adjust its digital code accordingly to decrease the current output of the turned on power links. This can involve turning off a larger number of columns within each PL.

FIG. 11D depicts an alternative to the use of switches SW0 to SW7 in FIG. 11A, in accordance with some embodiments. In this approach, the control circuit outputs a set of digital codes on paths 111a, one code for each power link, e.g., PL(0), PL(1, . . . , PL(7). The logic circuit 1160 outputs a set of control signals on paths 1161a to multipliers 1180, 1181 . . . , 1182 which determine whether the digital codes pass to their respective power link or are zeroed out. The zeroed out signals result in no power output from the respective power link, in one approach. The paths 111a may be input to the digital decoder 126, in one approach. The multipliers may be part of the logic circuit but are shown separately here. Each multiplier may implement a basic logic function to provide a value INPUT[PL(i)]=Digital code PL(i)*Output(i) of logic circuit, for each ith power link. Various other approaches are possible as well.

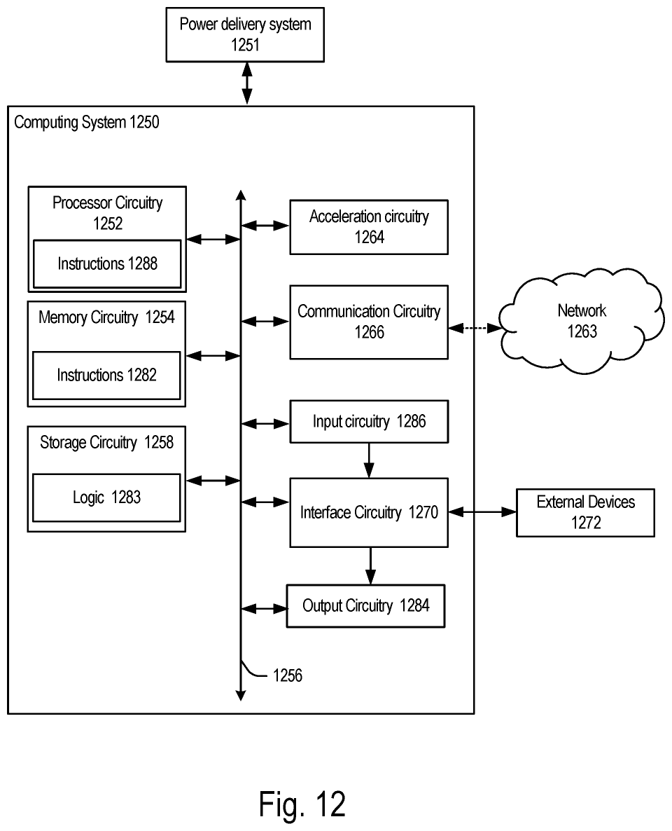

FIG. 12 illustrates an example of components that may be present in a computing system 1250 for implementing the techniques (e.g., operations, processes, methods, and methodologies) described herein. The power delivery system 1251 may represent the circuit 1100 of FIG. 11A, for example. The power delivery system 1251 provides power to the components of the computing system 1250.

The computing system 1250 may be powered by a power delivery subsystem 1251 and include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 1250, or as components otherwise incorporated within a chassis of a larger system. For one embodiment, at least one processor 1252 may be packaged together with computational logic 1282 and configured to practice aspects of various example embodiments described herein to form a System in Package (SiP), a System on Chip (SoC) or other circuit. The circuit can be part of a stacked tile/chiplet design which includes multiple integrated circuits/chips within the same package. The circuit can be considered to be an apparatus, a system or circuitry.

The system 1250 includes processor circuitry in the form of one or more processors 1252. The processor circuitry 1252 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1252 may include one or more hardware accelerators (e.g., same or similar to acceleration circuitry 1264), which may be microprocessors, programmable processing devices (e.g., FPGA, ASIC, etc.), or the like. The one or more accelerators may include, for example, computer vision and/or deep learning accelerators. In some implementations, the processor circuitry 1252 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor circuitry 1252 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low voltage processor, an embedded processor, or any other known processing elements, or any suitable combination thereof. The processors (or cores) 1252 may be coupled with or may include memory/storage and may be configured to execute instructions stored in the memory/storage to enable various applications or operating systems to run on the platform 1250. The processors (or cores) 1252 is configured to operate application software to provide a specific service to a user of the platform 1250. In some embodiments, the processor(s) 1252 may be a special-purpose processor(s)/controller(s) configured (or configurable) to operate according to the various embodiments herein.

As examples, the processor(s) 1252 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1252 may be a part of a system on a chip (SoC), System-in-Package (SiP), a multi-chip package (MCP), and/or the like, in which the processor(s) 1252 and other components are formed into a single integrated circuit, or a single package, such as the Edison™ or Galileo™ SoC boards from Intel® Corporation. Other examples of the processor(s) 1252 are mentioned elsewhere in the present disclosure.

The system 1250 may include or be coupled to acceleration circuitry 1264, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1264 may comprise logic blocks or logic fabric and other interconnected resources that may be programmed (configured) to perform various functions, such as the procedures, methods, functions, etc. of the various embodiments discussed herein. In such implementations, the acceleration circuitry 1264 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1252 and/or acceleration circuitry 1264 may include hardware elements specifically tailored for machine learning and/or artificial intelligence (AI) functionality. In these implementations, the processor circuitry 1252 and/or acceleration circuitry 1264 may be, or may include, an AI engine chip that can run many different kinds of AI instruction sets once loaded with the appropriate weightings and training code. Additionally or alternatively, the processor circuitry 1252 and/or acceleration circuitry 1264 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPS™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1252 and/or acceleration circuitry 1264 and/or hardware accelerator circuitry may be implemented as AI accelerating co-processor(s), such as the Hexagon 1285 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin 970 provided by Huawei®, and/or the like. In some hardware-based implementations, individual subsystems of system 1250 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 1250 also includes system memory 1254. Any number of memory devices may be used to provide for a given amount of system memory. As examples, the memory 1254 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1254 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1254 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 1258 provides persistent storage of information such as data, applications, operating systems and so forth. In an example, the storage 1258 may be implemented via a solid-state disk drive (SSDD) and/or high-speed electrically erasable memory (commonly referred to as “flash memory”). Other devices that may be used for the storage 1258 include flash memory cards, such as SD cards, microSD cards, XD picture cards, and the like, and USB flash drives. In an example, the memory device may be or may include memory devices that use chalcogenide glass, multi-threshold level NAND flash memory. NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1254 and/or storage circuitry 1258 may also incorporate three-dimensional (3D) cross-point (XPOINT) memories from Intel® and Micron®.

The memory circuitry 1254 and/or storage circuitry 1258 is/are configured to store computational logic 1283 in the form of software, firmware, microcode, or hardware-level instructions to implement the techniques described herein. The computational logic 1283 may be employed to store working copies and/or permanent copies of programming instructions, or data to create the programming instructions, for the operation of various components of system 1250 (e.g., drivers, libraries, application programming interfaces (APIs), etc.), an operating system of system 1250, one or more applications, and/or for carrying out the embodiments discussed herein. The computational logic 1283 may be stored or loaded into memory circuitry 1254 as instructions 1282, or data to create the instructions 1282, which are then accessed for execution by the processor circuitry 1252 to carry out the functions described herein. The processor circuitry 1252 and/or the acceleration circuitry 1264 accesses the memory circuitry 1254 and/or the storage circuitry 1258 over the interconnect (IX) 1256. The instructions 1282 direct the processor circuitry 1252 to perform a specific sequence or flow of actions, for example, as described with respect to flowchart(s) and block diagram(s) of operations and functionality depicted previously. The various elements may be implemented by assembler instructions supported by processor circuitry 1252 or high-level languages that may be compiled into instructions 1288, or data to create the instructions 1288, to be executed by the processor circuitry 1252. The permanent copy of the programming instructions may be placed into persistent storage devices of storage circuitry 1258 in the factory or in the field through, for example, a distribution medium (not shown), through a communication interface (e.g., from a distribution server (not shown)), over-the-air (OTA), or any combination thereof.

The IX 1256 couples the processor 1252 to communication circuitry 1266 for communications with other devices, such as a remote server (not shown) and the like. The communication circuitry 1266 is a hardware element, or collection of hardware elements, used to communicate over one or more networks 1263 and/or with other devices. In one example, communication circuitry 1266 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1266 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 1256 also couples the processor 1252 to interface circuitry 1270 that is used to connect system 1250 with one or more external devices 1272. The external devices 1272 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 1250, which are referred to as input circuitry 1286 and output circuitry 1284. The input circuitry 1286 and output circuitry 1284 include one or more user interfaces designed to enable user interaction with the platform 1250 and/or peripheral component interfaces designed to enable peripheral component interaction with the platform 1250. Input circuitry 1286 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1284 may be included to show information or otherwise convey information, such as sensor readings, actuator position(s), or other like information. Data and/or graphics may be displayed on one or more user interface components of the output circuitry 1284. Output circuitry 1284 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 1250. The output circuitry 1284 may also include speakers and/or other audio emitting devices, printer(s), and/or the like. Additionally or alternatively, sensor(s) may be used as the input circuitry 1284 (e.g., an image capture device, motion capture device, or the like) and one or more actuators may be used as the output device circuitry 1284 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 1250 may communicate over the IX 1256. The IX 1256 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 1256 may be a proprietary bus, for example, used in a SoC based system.

The number, capability, and/or capacity of the elements of system 1250 may vary, depending on whether computing system 1250 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1250 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a control circuit to provide a request for a current output from a power circuit, wherein the power circuit comprises set of power links, and each power link comprises a plurality of columns of transistors; a first monitoring circuit to monitor a resistance of one or more replica columns, which replica columns in the set of power links, and to provide a first output based on the resistance; a second monitoring circuit to monitor a dropout voltage of the set of power links, and to provide a second output based on the dropout voltage; and a logic circuit coupled to the first monitoring circuit and the second monitoring circuit to provide control signals to turn on or off power links in the power links, in response to the first output and the second output, to regulate an output voltage of the set of power links.

Example 2 includes the apparatus of Example 1, wherein the first output comprises an indication of a number of power links to turn on in the set of power links.

Example 3 includes the apparatus of Example 2, wherein the second output comprises an adjustment coefficient to adjust the number.

Example 4 includes the apparatus of Example 2 or 3, wherein when the dropout voltage is less than a lower threshold dropout voltage, the second output indicates the number of power links to turn on is to be overridden so that all of the power links are turned on when the dropout.

Example 5 includes the apparatus of any one of Examples 2-4, wherein when the dropout voltage is between a lower threshold dropout voltage and an upper threshold dropout voltage, the second output indicates the number of power links indicated by the first output is to be reduced.

Example 6 includes the apparatus of any one of Examples 2-5, wherein when the dropout voltage is greater than an upper threshold dropout voltage, the second output indicates the number of power links indicated by the first output is not to be changed.

Example 7 includes the apparatus of any one of Examples 1-6, wherein a decoder is to connect or disconnect a transistor in each column to a ground voltage or another fixed bias, in response to the request.

Example 8 includes the apparatus of any one of Examples 1-7, wherein the control circuit is to provide the request based on a comparison between the output voltage of the set of power links and a target voltage.

Example 9 includes the apparatus of any one of Examples 1-8, wherein the second monitoring circuit is to provide the second output based on a difference between a target voltage and a low-pass filtered version of an input voltage of the set of power links.

Example 10 includes the apparatus of any one of Examples 1-9, wherein: the one or more replica columns are in a local oscillator; and the first monitoring circuit is to determine a frequency of the local oscillator, and calculate the resistance based on the frequency.

Example 11 includes the apparatus of any one of Examples 1-10, wherein the resistance is a drain-to-source resistance of the one or more replica columns.

Example 12 includes the apparatus of any one of Examples 1-11, wherein the control signals compensate for changes in an input voltage of the set of power links while a ground voltage is applied to control gates of the transistors.

Example 1a includes a method performed by a processor or other circuit or computing device comprising: at a control circuit, providing a request for a current output from a power circuit, wherein the power circuit comprises a set of power links, and each power link comprises a plurality of columns of transistors; at a first monitoring circuit, monitoring a resistance of one or more replica columns and to provide a first output based on the resistance, wherein the one or more replica columns are replicas of the columns of transistors in the set of power links; at a second monitoring circuit, monitoring a dropout voltage of the set of power links, and to provide a second output based on the dropout voltage; and at a logic circuit coupled to the first monitoring circuit and the second monitoring circuit, providing control signals to turn on or off power links in the set of power links, in response to the first output and the second output, to regulate an output voltage of the set of power links.

Example 2a includes the method of claim 1a, further comprising: at a decoder, connecting or disconnecting a transistor in each column to a ground voltage or another fixed bias in response to the request.

Example 3a includes the method of claim 1a or 2a, further comprising: at the control circuit, providing the request based on a comparison between the output voltage of the set of power links and a target voltage.

Example 4a includes the method of any one of claims 1a to 3a, further comprising: at the second monitoring circuit, providing the second output based on a difference between a target voltage and a low-pass filtered version of an input voltage of the set of power links.

Example 5a includes the method of any one of claims 1a to 4a, wherein the one or more replica columns are in a local oscillator, the method further comprising: at the first monitoring circuit, determining a frequency of the local oscillator, and calculating the resistance based on the frequency.

Example 6a includes an apparatus comprising means to perform the method of any one of Examples 1a to 5a.

Example 7a includes non-transitory machine-readable storage including machine-readable instructions that, when executed, cause a processor or other circuit or computing device to implement the method of any one of Examples 1a to 5a.

Example 8a includes a computer program comprising instructions which, when the program is executed by a computer, cause the computer to carry out the method of any one of Examples 1a to 7a.

Example 13 includes an apparatus, comprising: a set of power links to generate an output voltage, wherein each power link comprises a plurality of columns of transistors, each column comprises one or more transistors, and the transistors of the plurality of columns are arranged in one or more rows; a decoder to provide column control signals in response to receipt of a digital request; for each respective power link, a set of column switches coupled to the decoder, wherein, each column switch of the set of column switches is coupled to a respective column of the set of columns and is opened or closed by a respective column control signal of the column control signals provided by the decoder; and a set of multipliers to provide the digital request, wherein to provide the digital request, the set of multipliers passes or blocks digital codes from a control circuit in response to a respective control signal from a logic circuit.

Example 14 includes the apparatus of Example 13, wherein the respective control signals from the logic circuit are to compensate for changes in an input voltage of the set of power links and a drain-to-source resistance of the transistors in the set of power links.

Example 15 includes the apparatus of Example 13 or 14, wherein a control loop of the respective control signals from the logic circuit is slower than a control loop of the respective column control signals from the decoder.

Example 16 includes the apparatus of any one of Examples 13-15, wherein each column switch is to inactivate a respective column when the column switch is turned on.

Example 13a includes a method performed by a processor or other circuit or computing device comprising: generating an output voltage at a set of power links, wherein each power link comprises a plurality of columns of transistors, each column comprises one or more transistors, and the transistors of the plurality of columns are arranged in one or more rows; providing column control signals in response to receipt of a digital request; wherein for each respective power link, a set of column switches is coupled to the decoder; wherein each column switch of the set of column switches is coupled to a respective column of the set of columns; opening or closing each column switch by a respective column control signal of the column control signals provided by the decoder; providing, at a set of multipliers, the digital request; and to provide the digital request, at the set of multipliers, passing or blocking digital codes from a control circuit in response to a respective control signal from a logic circuit.

Example 13b includes an apparatus comprising means to perform the method of Example 13a.

Example 13c includes non-transitory machine-readable storage including machine-readable instructions that, when executed, cause a processor or other circuit or computing device to implement the method of Example 13a.

Example 13d includes a computer program comprising instructions which, when the program is executed by a computer, cause the computer to carry out the method of Example 13a.

Example 17 includes a voltage regulator, comprising: a set of power links to generate an output voltage, wherein each power link comprises a plurality of columns of transistors; an output path coupled to the set of power links to provide power to a load; a control circuit to receive an output voltage of the load and a target voltage, wherein the control circuit is to provide an output voltage on an output path based on an error between the target voltage and the output voltage; a first monitoring circuit to monitor a drain-to-source resistance of one or more replica columns and to provide a first output based on the drain-to-source resistance, wherein the one or more replica columns are replicas of the columns of transistors in the set of power links; a second monitoring circuit to monitor a dropout voltage of the set of power links, and to provide a second output based on the dropout voltage; and a logic circuit coupled to the first monitoring circuit, the second monitoring circuit and the output path to regulate the output voltage.

Example 18 includes the voltage regulator of Example 17, wherein the logic circuit is to open or close respective power link switches of the set of power link switches.

Example 19 includes the voltage regulator of Example 17 or 18, wherein the logic circuit is to turn on a larger number of power links of the set of power links when the drain-to-source resistance of the one or more replica columns is larger.

Example 20 includes the voltage regulator of any one of Examples 17-19, further comprising: for each power link, a plurality of column switches to activate or inactivate columns of transistors of the plurality of columns of transistors of the power link; and a decoder to provide control signals to the plurality of column switches of each power link of the set of power links.

Example 17a includes a method performed by one or more processors or other circuits or computing devices, comprising: at a control circuit, receiving an output voltage of a load and a target voltage, wherein a set of power links is to generate the output voltage, each power link comprises a plurality of columns of transistors, an output path is coupled to the set of power links to provide power to a load, the control circuit is to provide the output voltage on the output path based on an error between the target voltage and the output voltage; at a first monitoring circuit, monitoring a drain-to-source resistance of one or more replica columns and providing a first output based on the drain-to-source resistance, wherein the one or more replica columns are replicas of the columns of transistors in the set of power links; at a second monitoring circuit, monitoring a dropout voltage of the set of power links, and providing a second output based on the dropout voltage; and at a logic circuit coupled to the first monitoring circuit, the second monitoring circuit and the output path, regulating the output voltage.

Example 17b includes an apparatus comprising means to perform the method of Example 17a.

Example 17c includes non-transitory machine-readable storage including machine-readable instructions that, when executed, cause a processor or other circuit or computing device to implement the method of Example 17a.

Example 17d includes a computer program comprising instructions which, when the program is executed by a computer, cause the computer to carry out the method of Example 17a.

In the present detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a control circuit to provide a request for a current output from a power circuit, wherein the power circuit comprises a set of power links, and each power link comprises a plurality of columns of transistors;
a first monitoring circuit to monitor a resistance of one or more replica columns and to provide a first output based on the resistance, wherein the one or more replica columns are replicas of the columns of transistors in the set of power links;
a second monitoring circuit to monitor a dropout voltage of the set of power links, and to provide a second output based on the dropout voltage; and
a logic circuit coupled to the first monitoring circuit and the second monitoring circuit to provide control signals to turn on or off power links in the set of power links, in response to the first output and the second output, to regulate an output voltage of the set of power links.

2. The apparatus of claim 1, wherein the first output comprises an indication of a number of power links to turn on in the set of power links.

3. The apparatus of claim 2, wherein the second output comprises an adjustment coefficient to adjust the number.

4. The apparatus of claim 2, wherein when the dropout voltage is less than a threshold dropout voltage, the second output indicates the number of power links to turn on is to be overridden so that all of the power links are turned on.

5. The apparatus of claim 2, wherein when the dropout voltage is between a lower threshold dropout voltage and an upper threshold dropout voltage, the second output indicates the number of power links indicated by the first output is to be reduced.

6. The apparatus of claim 2, wherein when the dropout voltage is greater than a threshold dropout voltage, the second output indicates the number of power links indicated by the first output is not to be changed.

7. The apparatus of claim 1, wherein a decoder is to connect or disconnect a transistor in each column to a ground voltage or another fixed bias in response to the request.

8. The apparatus of claim 1, wherein the control circuit is to provide the request based on a comparison between the output voltage of the set of power links and a target voltage.

9. The apparatus of claim 1, wherein the second monitoring circuit is to provide the second output based on a difference between a target voltage and a low-pass filtered version of an input voltage of the set of power links.

10. The apparatus of claim 1, wherein:
the one or more replica columns are in a local oscillator; and
the first monitoring circuit is to determine a frequency of the local oscillator, and calculate the resistance based on the frequency.

11. The apparatus of claim 1, wherein the resistance is a drain-to-source resistance of the one or more replica columns.

12. The apparatus of claim 1, wherein the control signals compensate for changes in an input voltage of the set of power links while a ground voltage is applied to control gates of the transistors.

13. An apparatus, comprising:
a set of power links to generate an output voltage, wherein each power link comprises a plurality of columns of transistors, each column comprises one or more transistors, and the transistors of the plurality of columns are arranged in one or more rows;
a decoder to provide column control signals in response to receipt of a digital request;
for each respective power link, a set of column switches coupled to the decoder, wherein, each column switch of the set of column switches is coupled to a respective column of the set of columns and is opened or closed by a respective column control signal of the column control signals provided by the decoder; and
a set of multipliers to provide the digital request, wherein to provide the digital request, the set of multipliers passes or blocks digital codes from a control circuit in response to a respective control signal from a logic circuit.

14. The apparatus of claim 13, wherein the respective control signals from the logic circuit are to compensate for changes in an input voltage of the set of power links and a drain-to-source resistance of the transistors in the set of power links.

15. The apparatus of claim 13, wherein a control loop of the respective control signals from the logic circuit is slower than a control loop of the respective column control signals from the decoder.

16. The apparatus of claim 13, wherein each column switch is to inactivate a respective column when the column switch is turned on.

17. A voltage regulator, comprising:
a set of power links to generate an output voltage, wherein each power link comprises a plurality of columns of transistors;
an output path coupled to the set of power links to provide power to a load;
a control circuit to receive an output voltage of the load and a target voltage, wherein the control circuit is to provide an output voltage on the output path based on an error between the target voltage and the output voltage;
a first monitoring circuit to monitor a drain-to-source resistance of one or more replica columns and to provide a first output based on the drain-to-source resistance, wherein the one or more replica columns are replicas of the columns of transistors in the set of power links;
a second monitoring circuit to monitor a dropout voltage of the set of power links, and to provide a second output based on the dropout voltage; and
a logic circuit coupled to the first monitoring circuit, the second monitoring circuit and the output path to regulate the output voltage.

18. The voltage regulator of claim 17, wherein the logic circuit is to open or close respective power link switches of the set of power link switches.

19. The voltage regulator of claim 17, wherein the logic circuit is to turn on a larger number of power links of the set of power links when the drain-to-source resistance of the one or more replica columns is larger.

20. The voltage regulator of claim 17, further comprising:
for each power link, a plurality of column switches to activate or inactivate columns of transistors of the plurality of columns of transistors of the power link; and
a decoder to provide control signals to the plurality of column switches of each power link of the set of power links.
